(19) United States
(12) Patent Application Publication
(10) Pub. No.: US 2009/0160176 A1
(43) Pub. Date: Jun. 25, 2009

(54) Carrier for boarding passes and personal documents

(76) Inventor: Mary C. Baeten, De Pere, WI (US)

Correspondence Address: STEVEN H GREENFIELD, 4649 SEMINOLE TRAIL, GREEN BAY, WI, 54313, US

(21) Appl. No.: 11/874,873

(22) Filed: Oct. 18, 2007

Related U.S. Application Data
(60) Provisional application No. 60/928,384, filed on May 9, 2007.

(51) Int. Cl. B42D 15/00; A45C 11/18

(52) U.S. Cl. 283/70; 283/75; 150/147

(57) ABSTRACT

A device for holding and carrying important papers and more particularly for travel documents, such as a photo ID and boarding passes, is disclosed. The device is designed for easy handling, placement and removal of the documents, and for permitting ticket counter agents, and airport gate and security check inspectors to readily view these documents. It utilizes envelope designs that are currently available on the market to which several modifications are made. A transparent pouch for holding and displaying a photo ID is laminated onto the front of the envelope and a strip is partially cut out from the front side of the envelope to form an aperture in the envelope. The aperture is used for inserting a boarding pass that is visible to allow ready inspection. The strip is used to seal the open side of the pouch to prevent the ID from accidentally falling out.

### RELATED APPLICATIONS

This application claims priority from provisional application No. 60/928,384 filed on May 9, 2007.

### FIELD OF THE INVENTION

The present invention relates to a device for holding and carrying personal papers, and more particularly for travel documents such as a photo ID and boarding passes. The device is designed for easy handling, placement and removal of these documents, and for permitting ticket counter agents, and airport gate and security check inspectors to readily view these documents.

### BACKGROUND OF THE INVENTION

Many US and international airports handle very large numbers of travellers on a daily basis. Because of safety concerns, passengers are typically required to go through routine security checks at several stops where they are required to show a personal identification document, such as a driver's license or a passport, for inspection. Likewise, the passengers are generally required to show their boarding passes for inspection or physically hand them to a flight attendant for tearing off a stub.

A passenger's first stop is normally the ticket counter where he or she shows a photo ID card such as a driver's license or passport. The passenger then checks his/her luggage and receives one or more boarding passes and a luggage receipt sticker. The boarding passes are inserted into specially made paper envelopes provided at the ticket counters by the airlines. These envelopes come in various designs having a single or multiple pockets and having one or two folds. A single pocket, double fold envelope is one of the common designs. It is made by double folding a continuous sheet such that two side panels are folded onto a center panel, and laminating the bottom part of one of the side panels to the bottom part of the center panel to create a compartment or pocket for the boarding passes.

As an alternative to a straight bottom to bottom lamination, a flap is folded and laminated over the combined bottom parts to create the compartment. The flap is usually about ¼″ to about ½″ extension of the bottom of the center panel. Other designs include two pockets on one side with a single fold, two pockets, one on each side, with a single fold, and two pockets, one on each side, with a double fold. Typical dimensions for these envelopes are about 8½″ in length and about 4″ in width.

A common variant of these designs is the addition of a slit to the center panel of the envelope perpendicular to the fold and about equidistance from top to bottom. The slit, typically about 3″-3½″ wide, is used for partially inserting the boarding pass of the passenger's first flight such that part of the pass is in front of the envelope thus permitting ready inspection by security or flight personnel and easy access to it.

After receiving the boarding passes, the passenger proceeds to the security check most likely with a carry on case and possibly a lap top and/or a purse. At the security check, the passenger is generally requested to again show a photo ID and the first flight boarding pass to a first security screener. The passenger will then place the carry-on luggage, lap top, purse and shoes into open containers to be x-rayed, go through a metal detector, where the passenger will occasionally be again required to show both a photo ID and the first flight boarding pass, then collect his/her belongings after they go through the x-ray machines.

The need to present a photo ID and boarding passes at multiple locations and times to security personnel has created a significant challenge for passengers as they must manage their tickets and boarding passes alongside other personal belongings without losing them in today's busy airport environment.

Prior art references disclose a variety of ways to manage this problem ranging from novel boarding pass envelope designs to special multiple pocket holders worn around the passengers' necks that contain both a driver's license and a boarding pass. U.S. Pat. No. 4,452,399 teaches a double pocket ticket envelope. It also refers to panels folded along score lines and requiring glue to secure to each other. U.S. Pat. No. 4,492,390 discloses an airline ticket holder comprising a front cover and a back cover and having a pocket between the two covers attached to the front cover. U.S. Pat. No. 6,003,758 relates to multiple pocket envelopes comprising several panels in which one panel is glued to another. U.S. Pat. No. 6,766,932 describes pockets for travel documents while U.S. Pat. No. 6,886,283 discloses a card holder with multiple pockets made of transparent film. U.S. Pat. No. 6,862,827 likewise refers to a holder for carrying and displaying a variety of travel related documents. The holder has clear pockets where the travel related documents placed therein are easily accessible by the user, easily viewed by security and boarding personnel, and the documents securely retained both within the holder and by an attachment means to the traveller. US pre-grant publication numbers 20030188815, 20060289612, 20030213826, 20040231216, and 20030213156 are directed to holders for carrying and displaying a variety of travel documents. The holders have transparent pockets for carrying airline tickets/boarding passes and personal identification. In pre-grant publication number 20030213156, the document holder may be configured with a variety of pockets, each pocket being coverable with a flap. Likewise pre-grant publication number 20040231216 discloses a flap that covers the pocket/pouch that contains the ID document. U.S. Pat. No. D485985 is an ornamental design for and ID and ticket holder.

### SUMMARY OF THE INVENTION

The device of the present invention is a holder and carrier for boarding passes and personal identification documents. The holder is designed for easy handling, placement and removal of the documents, and for permitting ticket counter agents, and airport gate and security check inspectors to readily view these documents. It utilizes envelope designs that are currently available on the market to which several modifications are made. A transparent pouch for holding and displaying a photo ID is laminated onto the front part of the envelope and a strip is partially cut out from the front side of the envelope to form an aperture in the envelope. The aperture is used for inserting a boarding pass such that it is visible and thus allows ready inspection. The strip is used to seal the open side of the pouch to prevent the ID from accidentally falling out while the holder is being carried through the airport.

It is the object of the present invention to provide a receptacle designed for securely holding and for the easy handling of a passenger's boarding passes and personal documentation such as a driver's license or passport in a busy airport environment.

It is also the object of the present invention to provide a carrier for boarding passes, luggage receipts, ticket receipts, and personal identification documents, such as a driver's license or a passport, which permits displaying them to security personnel upon request.

It is further the object of the present invention to provide a holder for boarding passes, luggage receipts, ticket receipts, and personal identification documents, such as a driver's license or a passport, which permits placing, accessing, and removing these documents with relative ease.

It is yet another object of the present invention to provide a holder for a passenger's luggage receipts, ticket receipts, and personal identification documents, such as a driver's license or a passport, which is disposable when no longer needed.

A significant benefit of the holder of the present invention is that it utilizes the envelopes currently provided by the airlines with only a few modest modifications. As with these envelopes, the device of the present invention is designed to be disposable. The type of plastic holder worn around the neck that is described in the prior art, by contrast, requires that the passenger remember to bring it to every flight. Also, the documents in these holders are not as easily accessible and removable compared with the device of the present invention.

### BRIEF DESCRIPTION OF THE DRAWINGS

FIG. 1 is a front view of the device showing the aperture used for inserting the boarding pass, the transparent pouch used for holding and displaying a photo ID, and the strip used for sealing the pouch opening.

FIG. 2 is a front view of the device featuring the aperture used for inserting the boarding pass, the transparent pouch used for holding and displaying a photo ID, the strip used for sealing the pouch opening, and a sample driver's license inserted inside the pouch.

FIG. 3 is a front view of the device illustrating the aperture used for inserting the boarding pass, the transparent pouch used for holding and displaying a photo ID, and a sample driver's license inserted inside the pouch. The strip is shown covering the pouch opening.

FIG. 4 is a front view of the device illustrating the aperture used for inserting the boarding pass, the transparent pouch used for holding and displaying a photo ID, and a sample driver's license inserted inside the pouch. The strip is shown fastened onto the top of the pouch and covering its opening. A sample boarding pass is shown inserted into the aperture.

FIG. 5 shows the back side of the envelope and features the inside pocket.

### DETAILED DESCRIPTION OF THE INVENTION

The holder is comprised of three rectangular panels of approximately equal size made by folding a continuous sheet; a center panel, a left panel and a right panel. Each panel is characterized as having a right side and a left side, a long side and a short side, a front side and a back side, a top side and a bottom side. The right and left sides correspond to the long side while the top and bottom correspond to the short side of each panel. The reference point for the left and right sides is in relation to facing the front of the center panel. The holder is constructed by folding the back side of the right panel onto the back side of the center panel and combining the back side bottom edges of the right and center panels together. The back side of the left panel is then folded over the right panel. In the preferred embodiment of this invention, the panels are made of paper and the described combination of the panels thus forms a paper envelope. Other materials, such as plastic film, cloth or leather also fall within the scope of this invention, however.

An alternative embodiment to this construction is folding the back side of the left panel onto the back side of the center panel and combining the back side bottom edges of the left and center panels together. The right panel is then folded over the left panel to close the envelope. The combination of the bottom edges may be accomplished by the use of an adhesive applied onto the back side bottom edge of the center panel, folding either left or right side panel over the center panel and applying pressure to the bottom edge of the combined panels to activate the adhesive. Alternatively, a strip of paper is laminated over the bottom edges of the combined center and left panels. The strip of paper may be an extension of the center panel bottom edge, or a separate piece of paper. Sealing the bottom edges of the center panel with either the right or left panels creates an inside pocket that can be used to hold the passenger's boarding passes, ticket receipt and luggage receipt. It should be understood that other envelope designs such as two pockets on one side with a single fold, two pockets, one on each side, with a single fold, and two pockets, one on each side, with a double fold also fall within the scope of this invention.

In the preferred embodiment of this invention, a strip of approximately 3″-3½″ by 1″ is partially cut out from about the middle of the center panel. The long side of the strip is parallel to the short side of the center panel and is cut from three sides: the top, the right and the left, with the bottom side left uncut, and folded out at the bottom to form a strip. The strip has a front side and a back side, and a top and bottom. The front side and back side of the strip correspond to the front side and the back side of the center panel from which it is cut. The top and a bottom of the strip parallel the top and the bottom of the center panel from which it is cut. The shape of the strip may be a rectangle or a 3-sided-equal trapezoid. However, other similar shapes also fall within the scope of this invention. The cut out strip forms an aperture in the center panel through which the boarding pass for the first flight is partially inserted such that the exposed part can be inspected by security personnel while in the holder and without the need for additional handling. A narrow layer of adhesive used for sealing the photo ID pouch is applied onto the front side of the strip near its top end. Three types of adhesives fall within the scope of this invention. One type is activated by wetting and applying pressure. Another type is activated only by applying pressure. The layer of this type of adhesive must be covered with release paper to prevent the accidental activation of the adhesive. The preferred embodiment of this invention is a third type of adhesive, one that binds only to itself and requires only pressure for activation. To achieve adhesion, a counterpart layer of adhesive is applied onto the pouch. The strip surface stays flush with the envelope surface until the pouch is ready to be sealed in order to prevent accidental closure of the pouch opening and activation of the adhesive. To insure this, the strip is not fully cut out of the aperture, thereby leaving small attachments between the sides of the strip and the envelope. These attachments are broken when the strip needs to be folded for sealing the pouch opening. Also in the preferred embodiment of this invention, the strip is perforated along a line that runs across its length at about the middle part relative to the top and bottom of the strip. The perforations permit unsealing the pouch opening with ease by tearing the strip open along the perforations.

A rectangular pouch made of transparent film having a right side and a left side, and a top side and a bottom side is laminated onto about the bottom half part of the center panel front side just below the aperture. The film is laminated at the bottom, the left and right sides leaving the top side open for inserting the passenger's driver's license or passport. In the preferred embodiment of the invention, a layer of adhesive of the type that binds only to itself is applied onto the top part of the transparent film. The layer is equal in shape and size to the layer of adhesive on the strip and is placed in a position that mirrors that of the adhesive layer on the folded strip sealing the pouch opening. The pouch's approximate dimension is 4″ by 3¼″, having its long side parallel the long side of the center panel.

A typical method for using the holder of the present invention is:

1. Following the check-in procedure that requires the inspection of the passenger's ID document and issuing the passenger's boarding passes, the boarding pass for the first flight is inserted in the center panel aperture, while the luggage receipt, ticket receipt and the boarding passes for the connecting flights are placed in the inside pocket of the envelope.

2. The passenger's photo ID is placed inside the pouch for safekeeping and for presentation at future inspections prior to boarding the first flight.

3. The strip is folded over the top of the transparent pocket and pressed onto it such that adhesion is achieved. This is intended to prevent the passenger's identification card from accidentally falling out.

4. The passenger uses the envelope for displaying and presenting the documents in future security inspections. At the boarding gate, the attendant may collect the boarding pass, scan it then return it to the passenger, or tear a portion off the pass and hand the other part to the passenger. The returned boarding pass may be placed back into the envelope aperture or into the inside pocket.

5. After the flights are completed, the envelope strip is torn open at the perforation, the personal ID and boarding passes are removed and the envelope is disposed of.

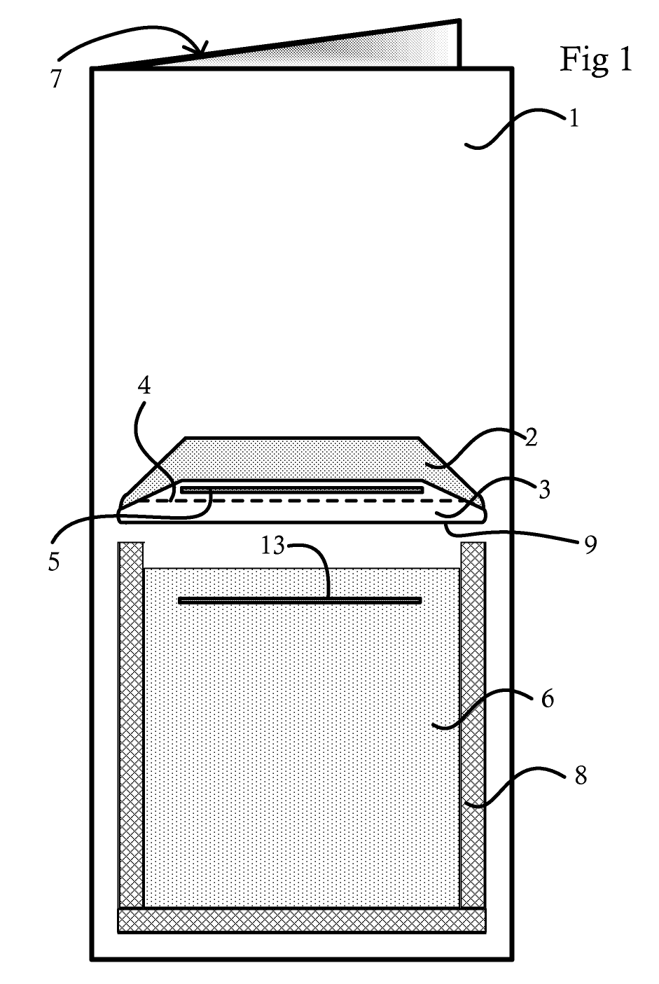

Referring to FIG. 1, the front of the center panel 1 has an aperture 2. The strip 3 cut out from the center panel 1 has a perforated line 4 and adhesive layer 5. The strip 3 is attached to the center panel 1 at the bottom 9. The left panel 7 is shown folded over the back of the center panel 1. Not shown is the right panel that was folded before the left panel. The transparent film of the pouch 6 is laminated at the right 8, left and bottom edges. A layer of adhesive of the type that sticks only to itself 13 is placed onto the top side of the pouch and mirrors the layer of adhesive on the strip 5. This type of adhesive represents the preferred embodiment of the invention.

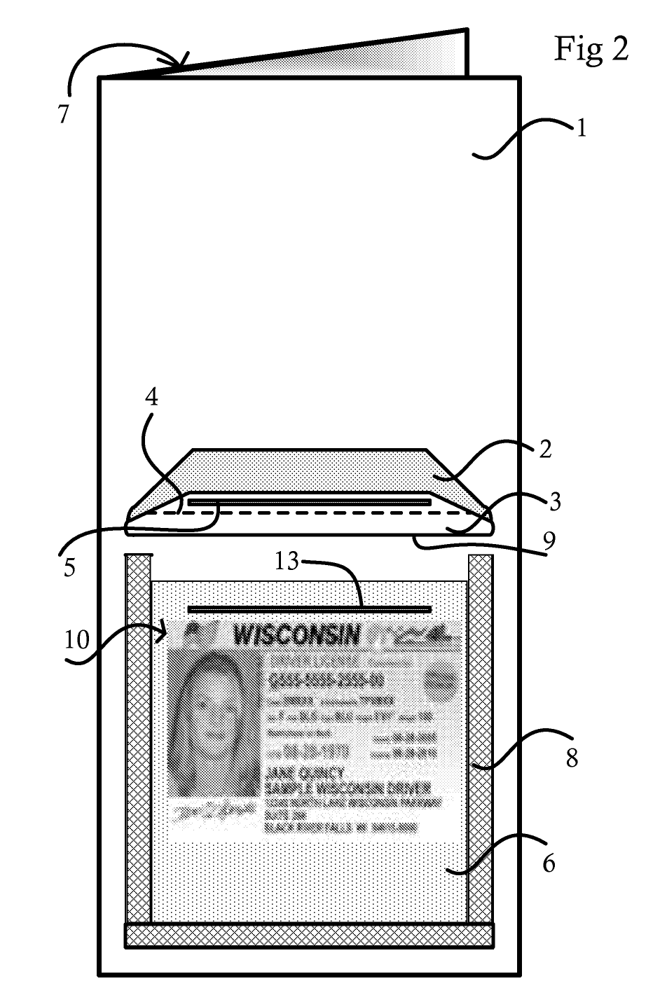

FIG. 2 shows all the elements of FIG. 1 and further indicates a sample driver's license 10 inserted inside the pouch 6.

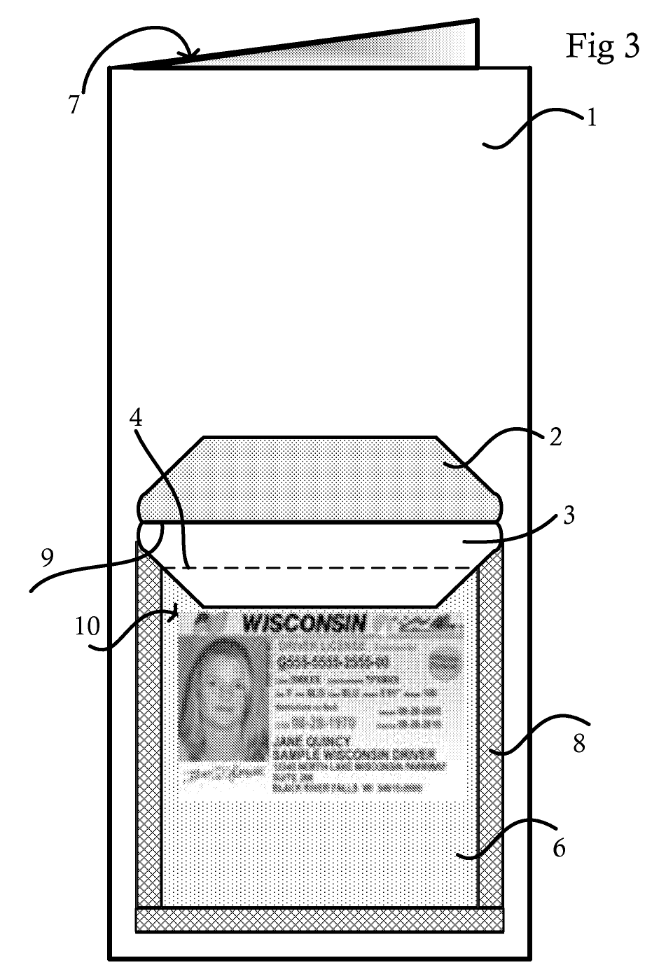

FIG. 3 illustrates all the elements of FIG. 2 and further shows the strip 3 covering the opening of the pouch 6 in order to prevent the driver's license 10 from accidentally falling out.

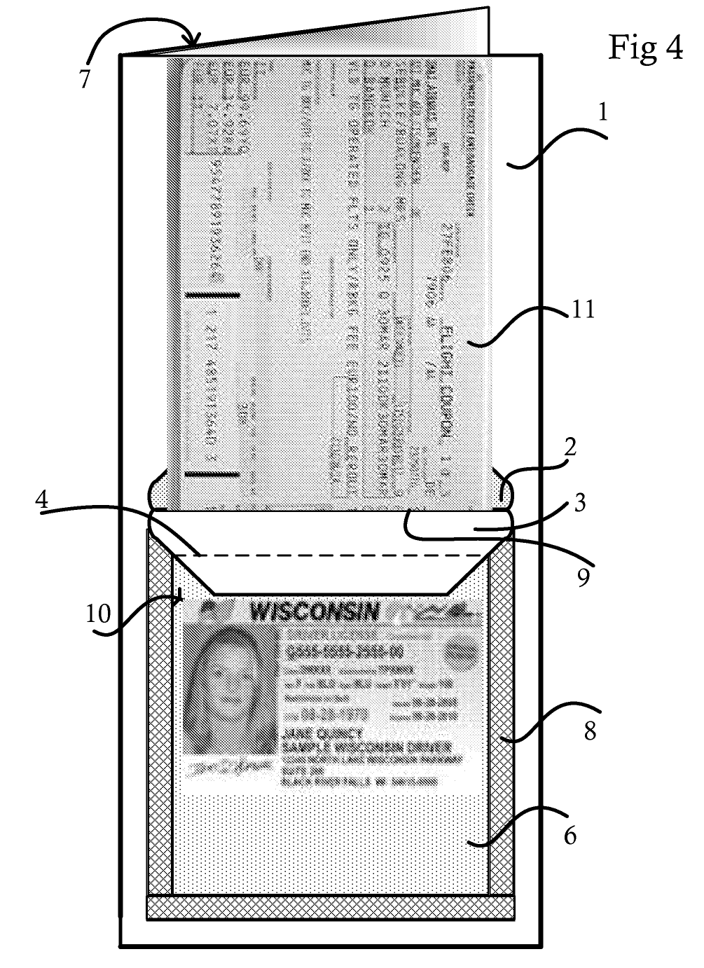

FIG. 4 illustrates all the elements of FIG. 3 and further shows a boarding pass 11 inserted inside the aperture of the center panel 2.

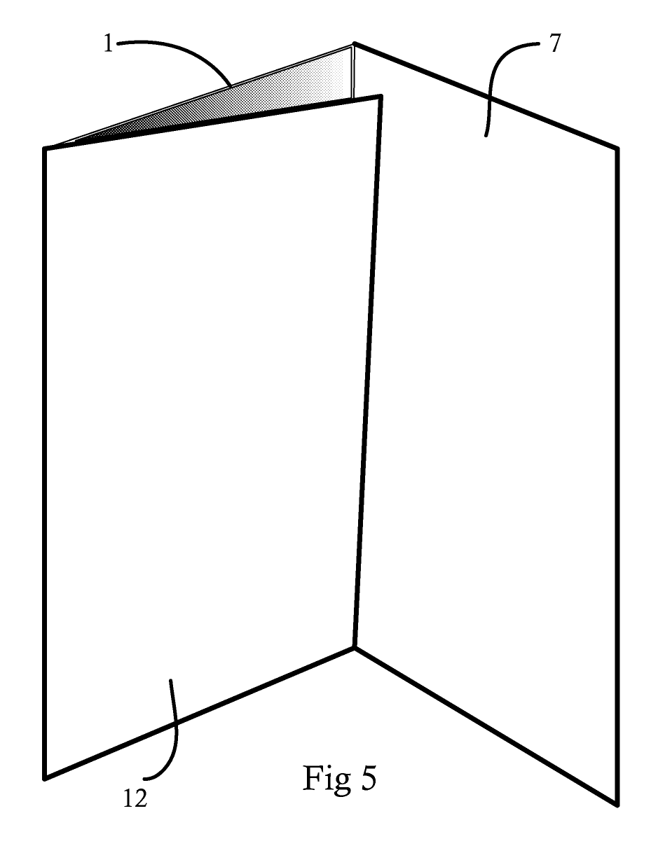

FIG. 5 shows the holder envelope from the inside. The right panel 12 is folded over the center panel 1 and their respective bottoms are glued together. The left panel 7 is shown open and is to be folded over the right panel 12 to close the envelope.

I claim:

1. A device comprising
(a) a first rectangular panel having a front side and a back side, having a length and a width, having a top side and a bottom side that correspond to the panel width, and having a left side and right side that correspond to the panel length, said first rectangular panel having an aperture at about the center of the first rectangular panel, said aperture having a length and a width, a bottom side and a top side, said length of said aperture being substantially parallel to the width of the panel, said width of said aperture being substantially parallel to the panel length;
(b) a second rectangular panel having a front side and a back side, having a length and a width, having a top side and a bottom side that correspond to the panel width, and having a left side and right side that correspond to the panel length, said right side of said second rectangular panel is pivotally connected to the left side of the first rectangular panel, said back side of the second rectangular panel is pivoted to contact the back side of said first rectangular panel, said bottom side of the first rectangular panel being combined with the bottom side of the second rectangular panel;
(c) a third rectangular panel having a front side and a back side, having a length and a width, having a top side and a bottom side that correspond to the panel width, and having a left side and right side that correspond to the panel length, the left side of said third rectangular panel is pivotally connected to the right side of the first rectangular panel, said back side of the third rectangular panel pivoted to contact the front side of said second rectangular panel;
(d) a strip having a front side and a back side, having a length and a width, having a right side and a left side, having a front side and a back side, and having a top side and a bottom side, said bottom side of said strip being connected to a portion of the first rectangular panel front side near the center of the front side of said first rectangular panel, said length of said strip running substantially parallel to the width of the panel, said width of said strip running substantially parallel to the length of the panel, said strip having an adhesive layer at the top side of the front of said strip, said adhesive layer running substantially across the length of the strip.

2. The device of claim 1, in which the shape of said strip is approximately rectangular.

3. The device of claim 1, in which the shape of said strip is approximately a three-sided-equal trapezoid.

4. The device of claim 1, wherein the adhesive layer on said strip comprises of an adhesive that is activated by pressure.

5. The device of claim 1, wherein the adhesive layer on said strip comprises of an adhesive that is activated by both moisture and pressure.

6. The device of claim 1, wherein the adhesive layer on said strip comprises of an adhesive that binds only to itself.

7. The device of claim 1, further comprising a perforated line across the length of said strip.

8. The device of claim 1, wherein said strip is cut out of the first rectangular panel to form the aperture in said first rectangular panel.

9. The device as in one of claims 4-8, in which the strip is cut at the right side, the left side and top side, said bottom part of said strip remaining attached to the first rectangular panel at the bottom of said aperture.

10. The device of claim 4, wherein release paper is placed over the adhesive layer.

11. The device of claim 1, in which the bottom side of the first rectangular panel is combined with the bottom side of the second rectangular panel by the use of an adhesive thereby forming an inside pocket between the first rectangular panel and the second rectangular panel.

12. The device of claim 11, in which the first rectangular panel, the second rectangular panel, and the third rectangular panel are made of paper and combined to form an envelope having two folds and an inside pocket.

13. The device as in claims 1 or 12, further comprising a pouch having a top side, a right side, a left side and a bottom side, said pouch is laminated onto the front side of the first panel bottom side.

14. The device of claim 13, wherein said pouch is made of transparent film.

15. The device of claim 14, wherein the pouch is laminated onto the first panel at the right side, the bottom side, and the left side, said top side of the pouch is not laminated.

16. The device of claim 15, wherein the top side of said pouch further comprises the adhesive layer that only binds to itself.

17. A method for carrying a photo ID and boarding passes of multiple flights using the device of claim 16 through various airport security checks comprising
a) inserting the boarding pass of the first flight having a blank side and a printed side into the aperture of the first rectangular panel having the printed side of said boarding pass face outwardly;
b) inserting the remaining boarding passes into the inside pocket of said device;
c) inserting the photo ID inside the transparent pouch having the photo face outwardly;
d) folding the strip over the top side of said pouch; and
e) pressing said strip onto the pouch top side to achieve adhesion.

18. The method of claim 17, further comprising carrying the device through airport security checks and presenting the boarding pass and photo ID secured inside the device to security personnel.

19. The method of claim 18, further comprising tearing the strip at the perforations and removing any boarding pass stubs and the photo ID following the conclusion of the flights.

20. The method of claim 19, further comprising properly disposing of the device.
